(19) United States
(12) Patent Application Publication
(10) Pub. No.: US 2015/0140221 A1
(43) Pub. Date: May 21, 2015

(54) TEXTILE COATING APPARATUS AND METHOD

(71) Applicant: JAMES DEWHURST LIMITED, Altham (GB)

(72) Inventor: Paul Cooper, Altham (GB)

(21) Appl. No.: 14/547,520

(22) Filed: Nov. 19, 2014

(30) Foreign Application Priority Data
Nov. 19, 2013 (GB) 1320438.3

(51) Int. Cl. D06M 15/19; B05C 1/08

(52) U.S. Cl. CPC D06M 15/19; B05C 1/0813; B05C 1/0808
USPC 427/372.2; 118/202; 118/68; 427/428.2

(57) ABSTRACT

An apparatus for coating a textile includes a coating reservoir for containing a textile coating composition, and one or more coolable rollers operable to convey a textile material through the apparatus and into contact with the coating composition, in a manner which considerably reduces build-up of the textile coating composition on the one or more rollers. Methods of using apparatus are also provided.

### CROSS-REFERENCE TO RELATED APPLICATION

This application claims priority under 35 U.S.C. §119(a)-(d) to United Kingdom Patent Application No. GB 1320438.3, filed on Nov. 19, 2013, which is hereby incorporated by reference in its entirety for all purposes.

### INTRODUCTION

The present invention relates to an apparatus for coating a textile, and a method of doing the same.

### BACKGROUND OF THE INVENTION

A variety of textile coating techniques are known in the art, and have been used for a diverse array of applications, including printing, water and fireproofing, and providing resistance to chemical attack. Textile coatings are also viewed as an effective solution for the flexible reinforcement of fibres, particularly when used in materials such as scrim, woven, laid or knitted fabrics.

Materials such as scrim can be manufactured by chemically bonding non-woven yarns together in an open, web-like construction. When compared with standard woven lattices, chemically-coated scrims can offer superior tear strength and dimensional stability characteristics owing to the fact that the straightness of the individual fibres is not as compromised by weaving or crimping.

Common coating application techniques include so-called dip and lick methods. Dip techniques involve conveying a textile under or around a rotating application roller that is at least partially submerged in a coating medium, such that the textile is dipped directly into the coating medium. Lick methods use a partially submerged application roller, which when rotated, licks the coating onto the surface of the roller, such that it can then be transferred to a textile in contact therewith. More elaborate techniques involve the use of multiple rollers, either to squeeze excess coating out of a coated textile, or to control the amount of coating that is eventually transferred to the textile.

Whilst such application techniques allow large quantities of textile to be continuously coated, they nevertheless suffer from processing draw-backs. In particular, the application rollers used in such techniques, or the like, when coming into direct or indirect contact with the coating composition can become coated with a layer of the coating composition, which when cured, forms a hardened film requiring production down-time to remove the film, or replace the roller. The problem is exacerbated when a heat source for drying the coated textile is in close proximity to the application rollers, as is frequently required.

The present invention was devised with the foregoing in mind.

### SUMMARY OF THE INVENTION

According to a first aspect of the present invention there is provided an apparatus for coating a textile material, the apparatus comprising a coating reservoir for containing a textile coating composition, and a conveyor assembly operable to convey a textile material through the apparatus and into contact with the textile coating composition, wherein the conveyor assembly comprises one or more rollers, each roller having an outer surface, at least one of the one or more rollers comprising cooling means for cooling the outer surface. Suitably, the reservoir contains the textile coating composition. The apparatus of the present invention addresses problems associated with film-forming on application rollers coming into direct or indirect contact with the textile coating composition by providing cooling means to cool the outer surface of the roller, or rollers, to prevent, or reduce, coating build-up. Direct contact will be understood to mean contact between the roller and the coating composition when the latter is contained within the reservoir. Indirect contact will be understood to mean contact between the roller with the coating composition when the latter is present either on a second roller, or on a textile. Suitably, the cooling means are operate to form a condensate, which acts as an intermediary layer on the outer surface, and prevents the accumulation of film-forming quantities of the coating composition. Optionally, the cooling means cool the outer surface below a minimum film-forming temperature of the particular textile coating composition in use. Such cooling means therefore prevent, or reduce, film-forming on the rollers, meaning that the apparatus requires less frequent servicing to remove hardened films or to replace spent rollers. The apparatus of the present invention therefore reduces production down-time, which translates into a significant cost saving.

In an embodiment, the one or more rollers are made from rubber, metal, plastic or a combination thereof. Suitably, the one or more rollers are made from aluminium, flash chromed carbon steel or stainless steel.

Suitably, the textile coating composition is heat curable. More suitably, the textile coating composition is curable above a temperature of 0° C. The apparatus of the present invention is particularly effective where the textile coating composition has a curing, or film-forming, temperature at or below ambient temperature.

In an embodiment, all of the one or more rollers comprise cooling means for cooling the outer surface of the rollers. In addition to a primary application roller, the apparatus may comprise one or more secondary rollers to either squeeze excess coating out of a coated textile, or to control the amount of coating that is eventually transferred to the textile. To the extent that they suffer from a coating build-up on their outer surfaces, some or all of these secondary rollers may comprise cooling means as defined herein.

In another embodiment, at least a portion of the cooling means is located inside the one or more rollers. In such embodiments, the roller is provided with an internal void, such that the outer surface of the roller may be cooled from the inside, thereby allowing for more efficient condensate formation on the outer surface. The cooling means may be located wholly, or only partially, within the roller. Where multiple cooled rollers are required, the cooling means may be a single unit, or separate individual units.

In a further embodiment, the cooling means comprise a circulatable coolant. Suitably, the coolant is a fluid. More suitably the coolant is a liquid. Consequently, the temperature of the coolant, and therefore of the outer surface, can be easily tailored to suit the specific ambient conditions and coating composition in use.

In another embodiment, the cooling means are operable to cool the outer surface to a temperature of 5-25° C. Optionally, the cooling means comprises a controller, operable to control or regulate the temperature of the outer surface. Principally, cooling means is operable to cool the outer surface to a temperature at which a condensate forms on the outer surface. Optionally, the cooling means is operable to cool the outer surface to a temperature below the minimum film-forming temperature of the particular coating composition in use. Suitably, the cooling means is operable such that the outer surface is not cooled to a temperature at or below which the viscosity of the particular coating composition increases to a point at which processing will be adversely affected. More suitably, the cooling means are operable to cool the outer surface to a temperature of 5-15° C. Even more suitably, the cooling means are operable to cool the outer surface to a temperature of 8-14° C. Suitably, the cooling means are operable to cool the outer surface to a temperature below the atmospheric dew point. Suitably, the cooling means are operable to cool the outer surface to a temperature at which a condensation forms on the outer surface. The dew point, and hence the temperature at which a condensate forms, may vary depending on the environment in which the apparatus is in use.

In still another embodiment, the outer surface further comprises a moisture-retaining covering. A moisture-retaining covering may be defined as any covering which increases the time that the condensate remains on the outer surface before evaporating. Suitably, the moisture-retaining covering comprises a fabric sleeve. When a moisture-retaining covering is not employed, the formed condensate is more likely to slip or drain off the smooth outer surface of the roller, meaning that the reduced film-forming characteristics of the apparatus are compromised. Applying a moisture-retaining covering, such as a fabric sleeve, prevents the surface of the roller from drying out quickly and therefore allows standard rollers, including rubber rollers, to be used more effectively. More suitably, the moisture-retaining covering is formed from wool, felt, or both. Such materials are typically inexpensive, and have been shown to confer improved moisture-retaining properties to the outer surface, as well as allowing for a more even distribution of coating composition.

In yet another embodiment, the apparatus further comprises drying means for drying a coated textile. The cooling means forming part of the present invention allows drying means, for drying a coated textile, to be placed in close proximity to the application roller, or rollers, without the risk of increased film-forming on their outer surfaces. This allows for more flexibility in the design of coating apparatuses. Suitably, the drying means are operable to dry a coated textile at a temperature of 120-180° C. Optionally the drying means is an infrared heater. Whilst some coating compositions may be dried at ambient temperature, production efficiency may be increased by drying at elevated temperatures.

In an embodiment, the textile coating composition is an aqueous adhesive solution. Suitably, the textile coating composition comprises one or more compounds selected from polyvinyl acetate, ethylene vinyl acetate, polyvinyl alcohol, polyvinyl chloride, latex, styrene butadiene, acrylic and polyethersulfone. More suitably, the textile coating composition comprises one or more compounds selected from polyvinyl alcohol and styrene butadiene. Even more suitably, the textile coating composition is a water-based polyvinyl alcohol or styrene butadiene adhesive.

In an embodiment, the reservoir is a bath. Suitably, the conveyor assembly is configured such that, in use, at least a portion of the outer surface remains in contact with the textile coating composition contained within the reservoir, such that rotation of the one or more rollers results in a coated outer surface. Accordingly, the present apparatus may be used to perform both dip and lick application techniques, wherein at least a portion of a roller remains in contact to the coating-containing reservoir. Despite being otherwise effective, such techniques necessarily result in the outer surface of the application roller being directly coated with the textile coating composition. However, the cooling means forming part of the present invention prevent such a coating layer from curing as a hardened film. Dip and lick techniques of this type may involve the use of additional rollers to either squeeze excess coating out of a coated textile, or to control the amount of coating that is eventually transferred to the textile.

Suitably, the conveyor assembly is configured such that, in use, rotation of the one or more rollers guides a textile material through the coating composition contained within the reservoir. The apparatus is therefore configured for use with so-called dip application techniques in which one or more rollers directs a textile into and through a reservoir containing the textile coating composition.

Suitably, the conveyor assembly is configured such that, in use, rotation of the one or more rollers transfers a portion of the textile coating composition to a textile material. The apparatus is therefore configured for use with so-called lick application techniques in which rotation of an application roller that is partially submerged in a reservoir containing a coating composition licks the coating onto the surface of the roller, which is then be transferred to a textile brought into contact therewith. The textile may be brought directly into contact with the coated roller, or the textile may be brought into contact with a second rotating roller, itself having an outer surface in contact with the coated roller.

Optionally, the conveyor assembly comprises first and second rollers, respectively having first and second outer surfaces. Suitably, the conveyor assembly is configured so as to be operable to sandwich a textile material between the first and second outer surfaces. Dip and lick techniques of this type may involve the use of additional rollers to squeeze excess coating out of a coated textile. Such techniques are generally termed dip squeeze and lick squeeze respectively. Most suitably, the conveyor assembly is operable such that, in use, a quantity of the textile coating composition on the coated outer surface is transferred to a textile material via the outer surface of a second roller. Lick techniques may therefore involve the use of additional rollers to control the amount of coating that is eventually transferred to the textile. Such multiple roller techniques are generally termed controlled lick.

According to a second aspect of the present invention, there is provided a method of coating a textile material, the method comprising the steps of:
a) providing an apparatus as defined herein,
b) cooling the outer surface of at least one of the one or more rollers, and
c) applying the textile coating composition to the textile material by operating the conveying assembly to convey the textile material through the apparatus and into contact with the textile coating composition.
   The method of the present invention addresses problems associated with film-forming on application rollers coming into direct or indirect contact with the textile coating composition by providing a cooling step to cool the outer surface of the roller, or rollers, to prevent, or reduce, coating build-up. Suitably, the cooling step results in the formation of a condensate, which acts as an intermediary layer on the outer surface, and prevents the accumulation of film-forming quantities of the coating composition. Optionally, the outer surface is cooled below a minimum film-forming temperature of the particular textile coating composition in use. The cooling step therefore prevents, or reduces, film-forming on the rollers, meaning that the apparatus requires less frequent servicing to remove hardened films or to replace spent rollers. The method of the present invention therefore reduces production down-time, which translates into a significant cost saving.

In an embodiment, step b) comprises circulating a coolant. The temperature of the coolant, and therefore of the outer surface, can be easily tailored to suit the specific ambient conditions and coating composition in use.

In another embodiment, step b) comprises cooling the outer surface to a temperature of 5-25° C. Principally, the outer surface is cooled to a temperature at which a condensate forms on the outer surface. Optionally, the outer surface is cooled to a temperature below the minimum film-forming temperature of the particular coating composition in use. Suitably, the outer surface is not cooled to a temperature at or below which the viscosity of the particular coating composition increases to a point at which processing will be adversely affected. More suitably, the outer surface is cooled to a temperature of 5-15° C. Even more suitably, the outer surface is cooled to a temperature of 8-14° C. Suitably, the outer surface is cooled to a temperature below the atmospheric dew point. Suitably, the outer surface is cooled to a temperature at which a condensation forms on the outer surface. The dew point, and hence the temperature at which a condensate forms, may vary depending on the environment in which the method is employed.

In another embodiment, the method further comprises the step of curing the textile material resulting from step c). Suitably, the step of curing comprises drying. The cooling step forming part of the present invention means that drying means for drying a coated textile may be placed in close proximity to the application roller, or rollers, without the risk of increased film-forming on their outer surfaces. This allows for more flexibility in the design of coating apparatuses. Suitably, the drying occurs at a temperature of 120-180° C. Optionally, the drying is via infrared heating. Whilst some coating compositions may be dried at ambient temperature, production efficiency may be increased by drying at elevated temperatures.

Suitably, step c) further comprises placing at least a portion of the outer surface in contact with the textile coating contained within the reservoir, and rotating the one or more rollers to result in a coated outer surface. Accordingly, the present method may be used as part of both dip and lick application techniques, wherein at least a portion of a roller remains in contact to the coating-containing reservoir. Despite being otherwise effective, such techniques necessarily result in the outer surface of the application roller being directly coated with the textile coating composition. However, the cooling step forming part of the present invention prevents such a coating layer from curing as a hardened film. Dip and lick techniques of this type may involve the use of additional rollers to either squeeze excess coating out of a coated textile, or to control the amount of coating that is eventually transferred to the textile.

Suitably, step c) further comprises rotating the one or more rollers to guide a textile to be coated through the textile coating composition contained within the reservoir. The present method may therefore be used as part of a so-called dip application technique in which one or more rollers directs a textile into and through a reservoir containing the textile coating composition.

Suitably, step c) further comprises contacting the textile material with the coated outer surface. The present method may therefore be used as part of a so-called lick application technique in which rotation of an application roller that is partially submerged in a reservoir containing a coating composition licks the coating onto the surface of the roller, which is then be transferred to a textile brought into contact therewith. The textile may be brought directly into contact with the coated roller, or the textile may be brought into contact with a second rotating roller, itself having an outer surface in contact with the coated roller.

Optionally, the conveyor assembly comprises first and second rollers, respectively having first and second outer surfaces. Suitably, step c) further comprises sandwiching the textile material between the first and second outer surfaces. Dip and lick techniques of this type may involve the use of additional rollers to squeeze excess coating out of a coated textile. Such techniques are generally termed dip squeeze and lick squeeze respectively. Most suitably, step c) further comprises:
transferring a quantity of the coating composition on the coated outer surface to the outer surface of a second rotating roller, and
contacting the textile material with the outer surface of the second rotating roller to coat the textile material.
   Lick techniques may therefore involve the use of additional rollers to control the amount of coating that is eventually transferred to the textile. Such multiple roller techniques are generally termed controlled lick.

In an embodiment, the textile material is an industrial textile. Suitably, the textile material comprises one or materials selected from glass fibres, polyester, polyvinyl chloride, polypropylene, nylon, rayon, aramid, carbon and natural fibres or yams. More suitably, the textile material is a continuous filament or spun material. Most suitably, the textile material is a scrim, woven, laid or knitted material.

According to a third aspect of the present invention, there is provided a coated textile obtained, directly obtained, or obtainable by any method defined herein.

### DETAILED DESCRIPTION OF THE INVENTION

One or more embodiments of the invention will now be described, by way of example only, with reference to the accompanying figures, in which:

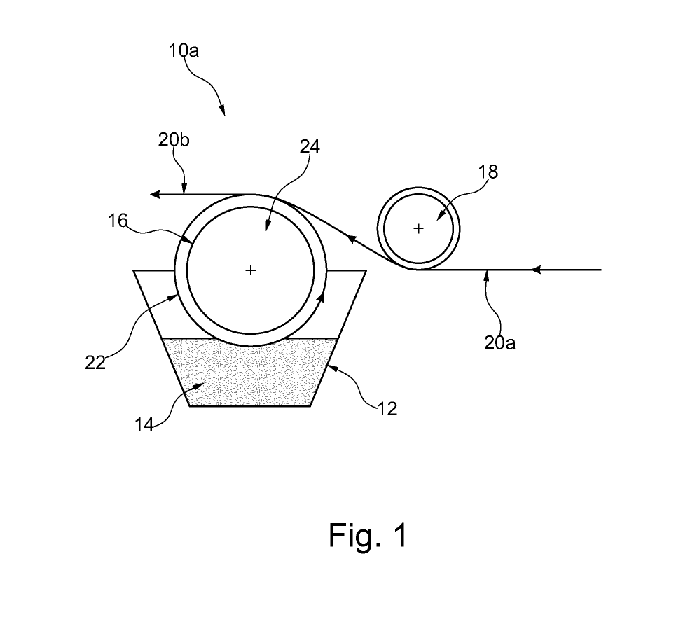

FIG. 1 is a schematic cross-section representation of a lick textile coating apparatus and method forming part of the present invention.

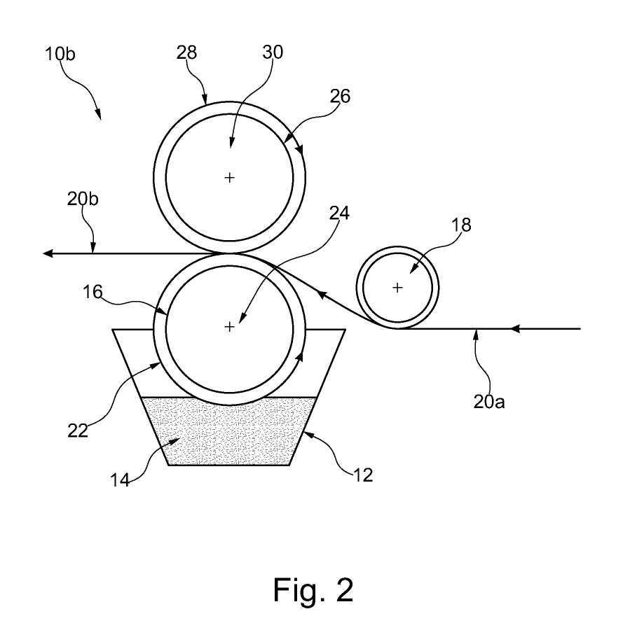

FIG. 2 is a schematic cross-section representation of a lick squeeze textile coating apparatus and method forming part of the present invention.

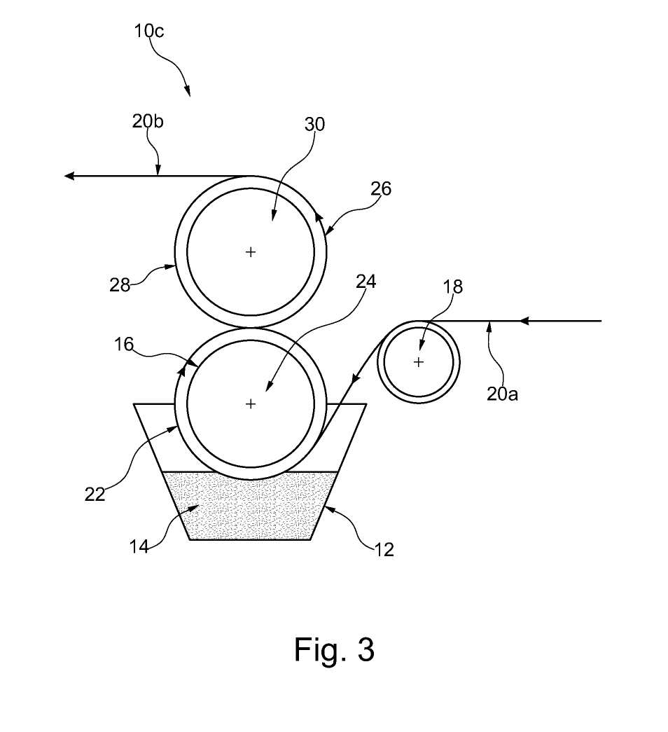

FIG. 3 is a schematic cross-section representation of a dip squeeze textile coating apparatus and method forming part of the present invention.

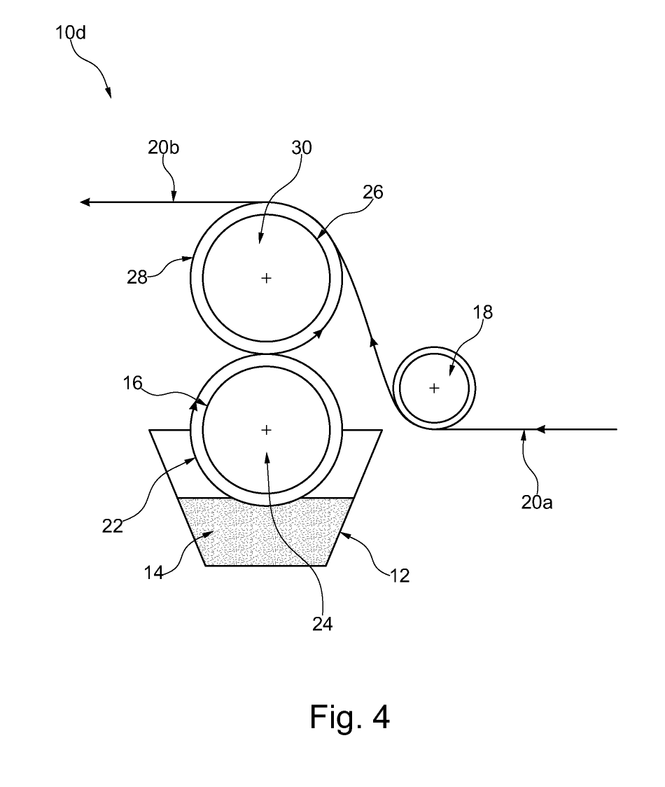

FIG. 4 is a schematic cross-section representation of a controlled lick textile coating apparatus and method forming part of the present invention.

Referring to FIGS. 1 to 4, a textile coating apparatus 10a, b, c, d includes a bath 12 containing a coating composition 14, a rotatable primary application roller 16 partially submerged along its length in the coating composition 14, and a rotatable guide roller 18 for guiding uncoated scrim fibres 20a into contact with the coating composition 14 to provide a coated scrim material 20b. Apparatus 10a,b,c,d further includes a heat source (not shown) located downstream of primary application roller 16 and serving to dry coated scrim material 20b at a temperature of 120-180° C.

Primary application roller 16 is made from aluminium and has an outer surface 22 and an internal cavity 24 extending along its length, within which is provided a circulating chilled water coolant having a temperature in the region of 5-15° C. Primary application roller 16 is also fitted with a shrink-on felt sleeve (not shown) covering outer surface 22.

Referring to FIG. 1, in use, primary application roller 16 of apparatus 10a is rotated anti-clockwise such that outer surface 22 becomes coated with a layer of coating composition 14. Guide roller 18 is then rotated to guide incoming uncoated scrim fibres 20a over an upper, unsubmerged portion of primary application roller 16, such that coating composition 14 present on outer surface 22 is transferred to uncoated scrim fibres 20a. The resulting coated scrim material 20b is then dried.

Referring to FIG. 2, apparatus 10b further includes a secondary application roller 26 also made from aluminium, and having an outer surface 28 and an internal cavity 30 extending along its length, within which is provided a circulating chilled water coolant having a temperature in the region of 5-15° C. Secondary application roller 26 is also fitted with a shrink-on felt sleeve (not shown) covering outer surface 28. Secondary application roller 26 is arranged directly above primary application roller 16, such that outer surfaces 22 and 28 are separated by a distance equating approximately to the thickness of coated scrim material 20b. In use, primary application roller 16 of apparatus 10b is rotated anti-clockwise such that outer surface 22 becomes coated with a layer of coating composition 14. Secondary application roller 26 is rotated anti-clockwise. Guide roller 18 is then rotated to guide incoming uncoated scrim fibres 20a over an upper, unsubmerged portion of primary application roller 16, such that coating composition 14 present on outer surface 22 is transferred to uncoated scrim fibres 20a. Coated scrim material 20b is then sandwiched between outer surfaces 22 and 28, such that any excess coating composition 14 present on coated scrim material 20b is squeezed off. The resulting coated scrim material 20b is then dried.

Referring to FIG. 3, apparatus 10c further includes a secondary application roller 26 also made from aluminium, and having an outer surface 28 and an internal cavity 30 extending along its length, within which is provided a circulating chilled water coolant having a temperature in the region of 5-15° C. Secondary application roller 26 is also fitted with a shrink-on felt sleeve (not shown) covering outer surface 28. Secondary application roller 26 is arranged directly above primary application roller 16, such that outer surfaces 22 and 28 are separated by a distance equating approximately to the thickness of coated scrim material 20b. In use, primary application roller 16 of apparatus 10c is rotated clockwise and secondary application roller 26 is rotated anti-clockwise. Guide roller 18 is then rotated to guide incoming uncoated scrim fibres 20a around a lower, submerged portion of primary application roller 16, such that coating composition 14 comes into direct contact with coating composition 14 contained within bath 12. Continued rotation of primary application roller 16 then sandwiches coated scrim material 20b between outer surfaces 22 and 28, such that any excess coating composition 14 present on coated scrim material 20b is squeezed off. The resulting coated scrim material 20b is then dried.

Referring to FIG. 4, apparatus 10d further includes a secondary application roller 26 also made from aluminium, and having an outer surface 28 and an internal cavity 30 extending along its length, within which is provided a circulating chilled water coolant having a temperature in the region of 5-15° C. Secondary application roller 26 is also fitted with a shrink-on felt sleeve (not shown) covering outer surface 28. Secondary application roller 26 is arranged directly above primary application roller 16, such that outer surfaces 22 and 28 are separated by a distance that allows transferral of a predetermined quantity of coating composition 14 from outer surface 22 to outer surface 28. In use, primary application roller 16 of apparatus 10d is rotated clockwise such that outer surface 22 becomes coated with a layer of coating composition 14. Coated outer surface 22 then contacts outer surface 28 of anti-clockwise-rotating secondary roller 26, such that a portion of coating composition 14 is transferred from outer surface 22 to outer surface 28. Guide roller 18 is then rotated to guide incoming uncoated scrim fibres 20a over outer surface 28 of secondary application roller 26, such that coating composition 14 present on outer surface 28 is transferred to uncoated scrim fibres 20a. The resulting coated scrim material 20b is then dried.

While specific embodiments of the invention have been described herein for the purpose of reference and illustration, various modifications will be apparent to a person skilled in the art without departing from the scope of the invention as defined by the appended claims. For example, the circulatable coolant is suitably chilled water provided from a mains system, although other well-known coolants, including compressed or uncompressed gases, are equally envisageable. Suitably, the cooling of primary and secondary application rollers 16 and 26 is controlled by a centralised system, although separate cooling systems are also envisaged, thereby allowing the temperature of outer surfaces 22 and 28 to be individually tailored according to their proximity to coating composition 14. Apparatus 10a, b, c, d may further include additional guide rollers 18 as required. Primary and secondary rollers 16 and 26 are suitably coated with a felt sleeve, although other fabrics, including wool, are also envisaged. Primary and secondary rollers 16 and 26 are suitably 2-5.6 m in length, having a diameter of 180-240 mm. Incoming uncoated textile fibres 20a are suitably scrim fibres made from glass. Other fibres may, however, be used depending on the end application, including polyester. Coated textile material 20b is suitably a scrim, which may have any known fibre geometry, including side-by-side, over/under, tri-directional or quad-directional. Alternatively, the apparatuses and processes of the present invention may be used to apply one or more substrates, such as glass mats or synthetic films, to an incoming formed scrim material. Other technical/industrial textiles, aside from scrim, are also envisaged, including woven, laid and knitted materials. The direction of rotation of the primary and/or secondary rollers 16 and 26 may be reversed depending on the direction of travel of the incoming uncoated scrim fibres 20a. Textile coating composition 14 is suitably an adhesive, although other compositions may be used depending on the intended end application. For example, coating compositions including inks, dyes, and those intended to confer waterproofing and/or fire retardant characteristics, may also be used in conjunction with the present invention. The apparatuses and methods of the present invention may also be used in conjunction with one or more doctor blades to meter the amount of coating composition 14 applied to the uncoated textile 20a.

It will be understood that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. An apparatus for coating a textile material, the apparatus comprising a coating reservoir for containing a textile coating composition, and a conveyor assembly operable to convey a textile material through the apparatus and into contact with the textile coating composition, wherein the conveyor assembly comprises one or more rollers, each roller having an outer surface, at least one of the one or more rollers being in direct contact with the coating composition when contained within the coating reservoir, said at least one of the one or more rollers comprising cooling means for cooling the outer surface.

2. The apparatus of claim 1, wherein the textile coating composition is curable above a temperature of 0° C.

3. The apparatus of claim 1, wherein all of the one or more rollers comprise cooling means for cooling the outer surface of the rollers.

4. The apparatus of claim 1, wherein at least a portion of the cooling means is located inside the one or more rollers.

5. The apparatus of claim 1, wherein the cooling means are operable to cool the outer surface to a temperature of 5-25° C.

6. The apparatus of claim 1, wherein the outer surface further comprises a moisture-retaining covering.

7. The apparatus of claim 1, wherein the apparatus further comprises drying means for drying a coated textile.

8. The apparatus of claim 2, wherein the textile coating composition comprises one or more compounds selected from polyvinyl acetate, ethylene vinyl acetate, polyvinyl alcohol, polyvinyl chloride, latex, styrene butadiene, acrylic and polyethersulfone.

9. The apparatus of claim 2, wherein the conveyor assembly is configured such that, in use, at least a portion of the outer surface remains in contact with the textile coating composition contained within the reservoir, such that rotation of the one or more rollers results in a coated outer surface.

10. A method of coating a textile material, the method comprising the steps of:
a) providing an apparatus as claimed claim 1, wherein the reservoir contains the textile coating composition,
b) cooling the outer surface of at least one of the one or more rollers, and
c) applying the textile coating composition to the textile material by operating the conveying assembly to convey the textile material through the apparatus and into contact with the textile coating composition.

11. The method of claim 10, wherein step b) comprises circulating a coolant.

12. The method of claim 10, further comprising the step of curing the textile material resulting from step c).

13. The method of claim 12, wherein the step of curing comprises drying.

14. The method of claim 10, wherein step c) further comprises placing at least a portion of the outer surface in contact with the textile coating contained within the reservoir, and rotating the one or more rollers to result in a coated outer surface.

15. The method of claim 10, wherein the conveyor assembly comprises first and second rollers, respectively having first and second outer surfaces.

16. The method of claim 14, wherein step c) further comprises:
transferring a quantity of the coating composition on the coated outer surface to the outer surface of a second rotating roller, and
contacting the textile material with the outer surface of the second rotating roller to coat the textile material.

17. The method of claims 10, wherein the textile material is an industrial textile.

18. The method of claim 10, wherein the textile material is a continuous filament or spun material.

19. The method of claim 10, wherein the textile material is a scrim, woven, laid or knitted material.
